(19) United States
(12) Patent Application Publication
(10) Pub. No.: US 2026/0135980 A1
(43) Pub. Date: May 14, 2026

(54) AUTOMATIC DISPARITY ADJUSTMENT METHOD AND SYSTEM

(71) Applicant: Acer Incorporated, New Taipei City (TW)

(72) Inventor: Tsung-Wei Tu, New Taipei City (TW)

(73) Assignee: Acer Incorporated, New Taipei City (TW)

(21) Appl. No.: 19/294,320

(22) Filed: Aug. 8, 2025

(30) Foreign Application Priority Data
Nov. 12, 2024 (TW) 113143305

(51) Int. Cl. H04N 13/128; H04N 13/00; H04N 13/139; H04N 13/239; H04N 13/366

(52) U.S. Cl. CPC H04N 13/128; H04N 13/139; H04N 13/239; H04N 13/366; H04N 2013/0081

(57) ABSTRACT

An automatic disparity adjustment system, including a pair of cameras and a controller. The pair of cameras are configured to photograph an object, so as to obtain a first image and a second image. The pair of cameras include two lenses with a distance therebetween. The controller is signally connected to the pair of cameras, and configured to execute the following steps. The first image is corrected with a first correction matrix, and the second image is corrected with a second correction matrix. A first corrected image and a second corrected image are cropped. A comfortable range of a binocular vergence distance is defined according to a viewing distance from a stereoscopic display to eyes of a user. A corrected binocular disparity is calculated according to the comfortable range, a first cropped image, and a second cropped image. An automatic disparity adjustment method is also provided.

### CROSS-REFERENCE TO RELATED APPLICATION

This application claims the priority benefit of Taiwan application serial no. 113143305, filed on Nov. 12, 2024. The entirety of the above-mentioned patent application is hereby incorporated by reference herein and made a part of this specification.

### BACKGROUND

### Technical Field

The disclosure relates to an automatic disparity adjustment method and an automatic disparity adjustment system.

### Description of Related Art

In recent years, stereoscopic display technology has been rapidly developing, and various optical systems for stereoscopic displays have emerged. Current stereoscopic displays typically have the issue of visual vergence-accommodation conflict (VAC).

Visual vergence-accommodation conflict occurs due to the difference between the monocular accommodation distance and the binocular vergence distance, further leading to confusion in the human brain, which makes users prone to dizziness. Therefore, how to design an optical solution that can overcome visual vergence-accommodation conflict remains a primary challenge in stereoscopic display technology.

On the other hand, to obtain stereoscopic image content for display on stereoscopic displays, a stereoscopic camera may be used to photograph objects. Conventional stereoscopic cameras use two sub-cameras to photograph objects, simulating the disparity effect generated by human eyes when viewing objects. However, when the binocular disparity of the left-eye image and the right-eye image captured by the stereoscopic camera is applied to the stereoscopic display, it may easily result in the issue of visual vergence-accommodation conflict.

### SUMMARY

The disclosure provides an automatic disparity adjustment method, which may effectively suppress the issue of visual vergence-accommodation conflict.

The disclosure provides an automatic disparity adjustment system, which may effectively suppress the issue of visual vergence-accommodation conflict.

An embodiment of the disclosure provides an automatic disparity adjustment method including the following steps. An object is photographed using a pair of cameras to obtain a first image and a second image. A distance exists between two lenses of the pair of cameras. The first image is corrected using a first correction matrix to obtain a first corrected image, and the second image is corrected using a second correction matrix to obtain a second corrected image. The first corrected image and the second corrected image simulate two images obtained by the pair of cameras when two optical axes of the two lenses are parallel. The first corrected image and the second corrected image are cropped to retain overlapping portions of the first corrected image and the second corrected image. A first cropped image is obtained after the first corrected image is cropped, and a second cropped image is obtained after the second corrected image is cropped. A binocular disparity of the first cropped image and the second cropped image is estimated according to a focal length of the two lenses, a pixel size of the pair of cameras, the first cropped image, and the second cropped image. A viewing distance from a stereoscopic display to an eye of a user is measured. A comfortable range of a binocular vergence distance is defined according to the viewing distance. A corrected binocular disparity is calculated according to the comfortable range, the first cropped image, and the second cropped image. The stereoscopic display is caused to display a stereoscopic image according to the corrected binocular disparity.

An embodiment of the disclosure provides an automatic disparity adjustment system including a pair of cameras and a controller. The pair of cameras are used to photograph an object to obtain a first image and a second image. The pair of cameras includes two lenses, and a distance exists between the two lenses. The controller is signally connected to the pair of cameras and configured to execute the following steps. The first image is corrected using a first correction matrix to obtain a first corrected image, and the second image is corrected using a second correction matrix to obtain a second corrected image. The first corrected image and the second corrected image simulate two images obtained by the pair of cameras when two optical axes of the two lenses are parallel. The first corrected image and the second corrected image are cropped to retain overlapping a portion of the first corrected image and the second corrected image. A first cropped image is obtained after the first corrected image is cropped, and a second cropped image is obtained after the second corrected image is cropped. A binocular disparity of the first cropped image and the second cropped image is estimated according to a focal length of the two lenses, a pixel size of the pair of cameras, the first cropped image, and the second cropped image. A comfortable range of a binocular vergence distance is defined according to a viewing distance from a stereoscopic display to an eye of a user. A corrected binocular disparity is calculated according to the comfortable range, the first cropped image, and the second cropped image. A stereoscopic image signal having the corrected binocular disparity is output to the stereoscopic display.

In the automatic disparity adjustment method and the automatic disparity adjustment system of the embodiments of the disclosure, a comfortable range of a binocular vergence distance is defined according to the viewing distance from the stereoscopic display to the eye of the user. Moreover, a corrected binocular disparity is calculated according to the comfortable range, the first cropped image, and the second cropped image. Therefore, the binocular vergence distance of the stereoscopic image displayed by the stereoscopic display according to the corrected binocular disparity lies within the comfortable range, effectively mitigating the issue of visual vergence-accommodation conflict. Accordingly, the automatic disparity adjustment method and the automatic disparity adjustment system of the embodiments of the disclosure may effectively suppress the issue of visual vergence-accommodation conflict.

### BRIEF DESCRIPTION OF THE DRAWINGS

FIG. 1 is a schematic diagram of an automatic disparity adjustment system according to an embodiment of the disclosure.

FIG. 2 illustrates the monocular accommodation distance, the binocular vergence distance, and the comfortable range when the user's eyes view the stereoscopic display in FIG. 1.

FIG. 3 is a diagram showing the relationship of binocular disparity relative to the distance between the eyes and the stereoscopic display when (β−α)/2 equals −0.5° and +0.5°.

FIG. 4 is a flowchart of the automatic disparity adjustment method performed by the automatic disparity adjustment system of FIG. 1.

FIG. 5A is a schematic diagram showing the errors of the two actual imaging planes of a pair of cameras in the automatic disparity adjustment system of FIG. 1.

FIG. 5B is a schematic diagram showing the two virtual imaging planes of a pair of cameras in the automatic disparity adjustment system.

FIG. 6 illustrates the first corrected image and the second corrected image obtained after correcting the first image and the second image acquired by the pair of cameras in FIG. 1 using correction matrices.

FIG. 7 is a schematic diagram showing the first image, the second image, the first corrected image, and the second corrected image overlaid together.

FIG. 8 is a structural diagram of the pair of cameras in FIG. 1.

FIG. 9 is a schematic diagram showing the resolution adjustment of the first cropped image and the second cropped image back to the resolutions of the first image and the second image.

FIG. 10 is a basic configuration diagram when the user views the stereoscopic display in FIG. 1.

FIG. 11 is a schematic diagram showing the resolution scaling of the camera images in FIG. 1 to the resolution of the stereoscopic display.

### DESCRIPTION OF THE EMBODIMENTS

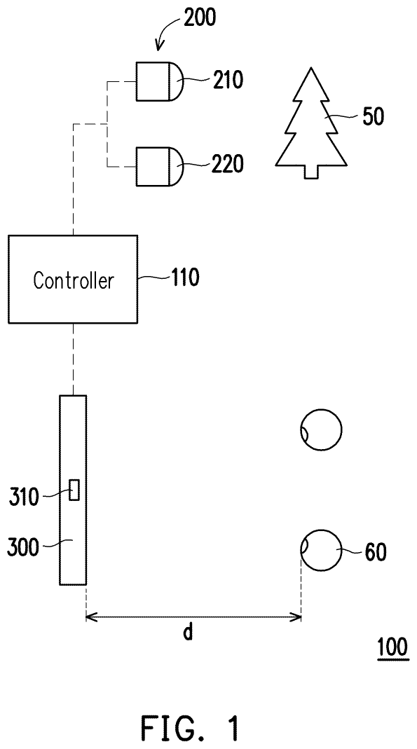

FIG. 1 is a schematic diagram of an automatic disparity adjustment system according to an embodiment of the disclosure. Referring to FIG. 1, the automatic disparity adjustment system 100 of this embodiment includes a pair of cameras 200 and a controller 110. The pair of cameras 200 is used to photograph an object 50 to obtain a first image and a second image. Specifically, the pair of cameras 200 includes two lenses 210 and 220, and a distance exists between the two lenses 210 and 220. Therefore, there is binocular disparity between the first image and the second image. In other words, the pair of cameras 200 may, for example, be a stereoscopic camera. The controller 110 is signally connected to the pair of cameras 200. Here, “signally connected” refers to a connection through physical wires where signals are transmitted within the physical wires, or a connection through wireless communication where signals are transmitted as wireless signals. After processing the first image and the second image, the controller 110 outputs the processed signals to a stereoscopic display 300, allowing the stereoscopic display 300 to display stereoscopic images for viewing by an eye 60 of a user. The controller 110 may also be signally connected to the stereoscopic display 300.

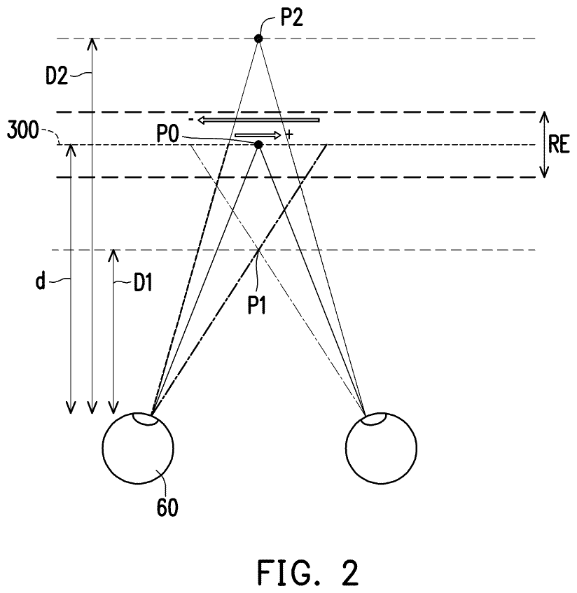

FIG. 2 illustrates the monocular accommodation distance, the binocular vergence distance, and the comfortable range when the user's eyes view the stereoscopic display in FIG. 1. Referring to FIG. 1 and FIG. 2, a distance d between the user's eye 60 and the stereoscopic display 300 is the monocular accommodation distance. When the stereoscopic image is located at a point P0 on the stereoscopic display 300, the lines of sight of the user's eyes converge at the point P0 on the stereoscopic display 300. At this time, the binocular vergence distance is also d, and the binocular disparity is 0. When the stereoscopic image is located at a point P1 in front of the stereoscopic display 300 in space, the lines of sight of the user's eyes converge at the point P1 in front of the stereoscopic display 300 in space. At this time, the binocular vergence distance is D1, which is less than d, and the binocular disparity is a negative value. When the stereoscopic image is located at a point P2 behind the stereoscopic display 300 in space, the lines of sight of the user's eyes converge at the point P2 behind the stereoscopic display 300 in space. At this time, the binocular vergence distance is D2, which is greater than d, and the binocular disparity is a positive value.

When the binocular vergence distance is equal to the distance d, and the convergence point of the user's binocular lines of sight is located on the stereoscopic display 300, the angle between the binocular lines of sight is α. Regardless of whether the binocular vergence distance is greater than, equal to, or less than the distance d, the angle between the binocular lines of sight is β. Experimental verification shows that when |(β−α)/2|≤0.5°, the user is less likely to experience visual vergence-accommodation conflict. This corresponds to a comfortable range RE in FIG. 2. In other words, when the stereoscopic image is located within the comfortable range RE, the user is less likely to experience visual vergence-accommodation conflict and may have a comfortable viewing experience. Adjusting the stereoscopic image to stay within this range is the goal of the automatic disparity adjustment system of this embodiment.

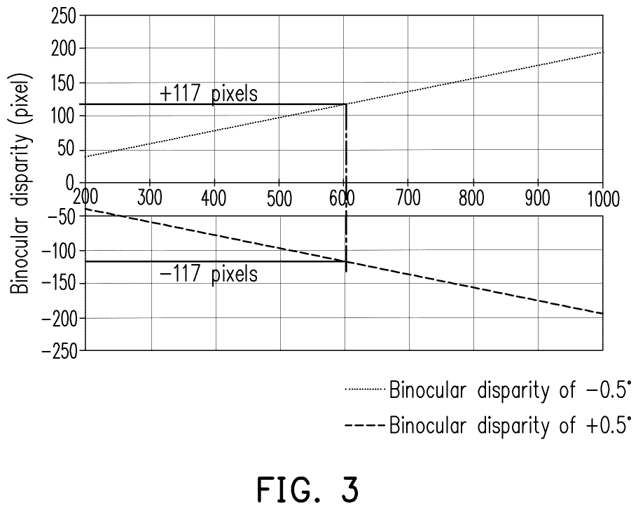

FIG. 3 is a diagram showing the relationship of binocular disparity relative to the distance between the eyes and the stereoscopic display when (β−α)/2 equals −0.5° and +0.5°, respectively. Referring to FIGS. 1 to 3, as shown in FIG. 3, when the distance d between the eye 60 and the stereoscopic display 300 is 600 millimeters, the corresponding binocular disparity is +117 pixels when (β−α)/2 equals −0.5°, and the corresponding binocular disparity is −117 pixels when (β−α)/2 equals +0.5°.

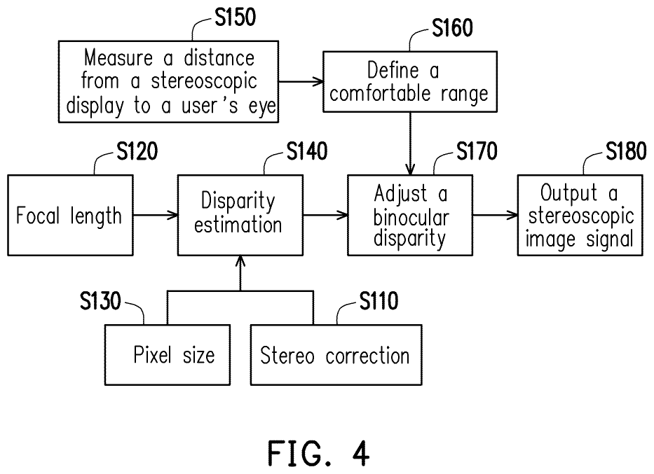

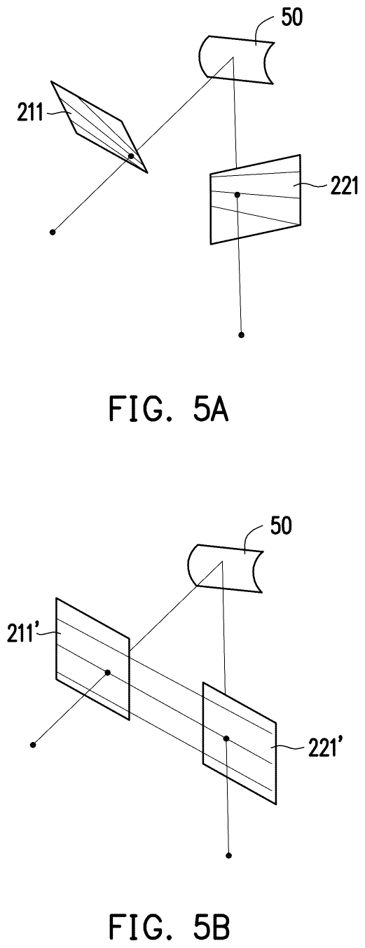

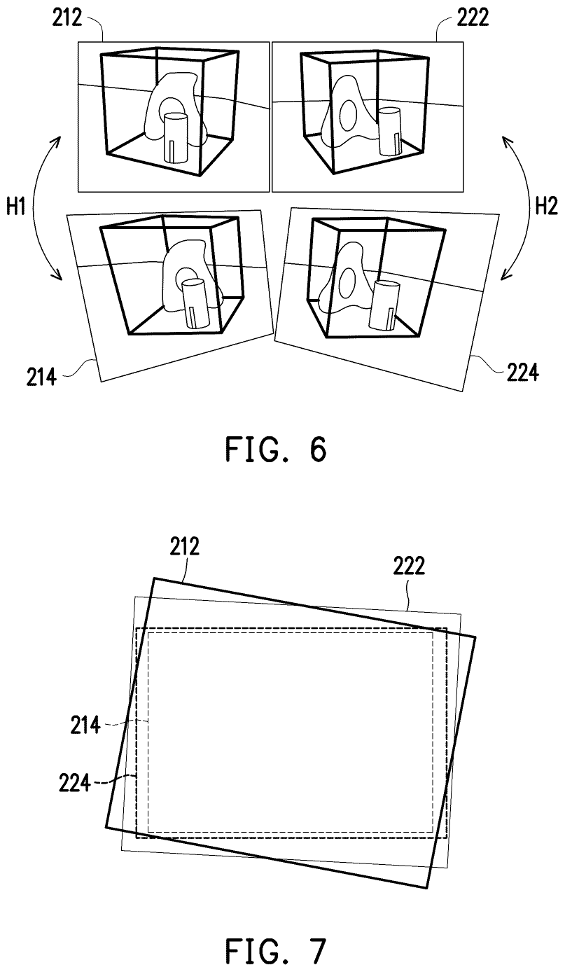

FIG. 4 is a flowchart of the automatic disparity adjustment method executed by the automatic disparity adjustment system in FIG. 1. FIG. 5A is a schematic diagram showing the errors of two actual imaging planes of a pair of cameras in the automatic disparity adjustment system in FIG. 1. FIG. 5B is a schematic diagram showing two virtual imaging planes of a pair of cameras in the automatic disparity adjustment system. FIG. 6 illustrates the first corrected image and the second corrected image obtained after correcting the first image and the second image acquired by the pair of cameras in FIG. 1 using correction matrices. Referring to FIGS. 1, 4, 5A, 5B, and 6, the controller 110 of this embodiment is configured to execute the following steps. First, in step S110, a first correction matrix H1 is used to correct a first image 212 to obtain a first corrected image 214, and a second correction matrix H2 is used to correct a second image 222 to obtain a second corrected image 224. The first corrected image 214 and the second corrected image 224 simulate the two images obtained by the pair of cameras 200 when the optical axes of the two lenses 210 and 220 are parallel.

Specifically, as shown in FIG. 5A, due to assembly errors, the optical axes of lens 210 and lens 220 may be misaligned and not parallel. In other words, an actual imaging plane 211 of lens 210 and an actual imaging plane 221 of lens 220 may not be parallel. Therefore, correction matrices H1 and H2, which are capable of rotating and translating the images, may be used to correct the first image 212 and the second image 222, respectively. After this correction, the first corrected image 214 and the second corrected image 224 simulate the two images obtained by the pair of cameras 200 when the optical axes of the two lenses 210 and 220 are parallel. This simulates the images captured on two parallel and coplanar virtual imaging planes 211′ and 221′.

FIG. 7 is a schematic diagram showing the overlay of the first image, the second image, the first corrected image, and the second corrected image. Next, the processor 110 crops the first corrected image 214 and the second corrected image 224 to retain the overlapping portions of the first corrected image 214 and the second corrected image 224. In the example shown in FIG. 7, the overlapping portion is, for instance, the first corrected image 214, so the edges of the second corrected image 224 need to be cropped, while the range of the first corrected image 214 remains unchanged after cropping, effectively resulting in no cropping. After cropping, a first cropped image is obtained from the first corrected image 214, and a second cropped image is obtained from the second corrected image 224.

Then, according to the focal length f of the two lenses 210 and 220 (step S120), the pixel sizes of the pair of cameras 200 (step S130), the first cropped image, and the second cropped image (step S110), the binocular disparity of the first cropped image and the second cropped image is estimated (step S140).

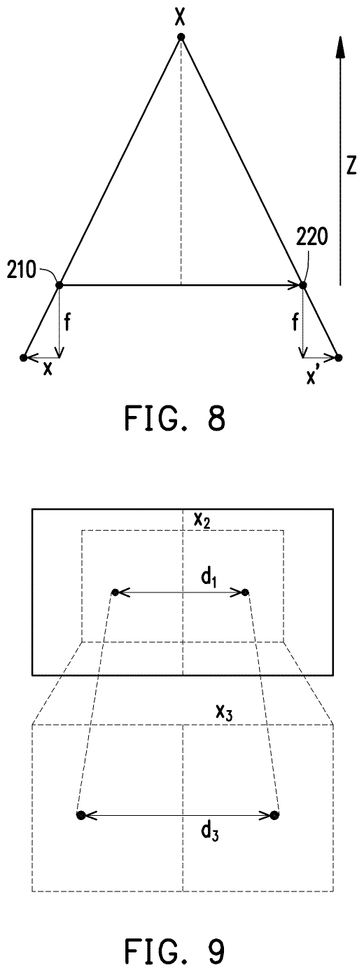

FIG. 8 is a structural diagram of the pair of cameras in FIG. 1. Referring to FIGS. 1, 4, and 8, in FIG. 8, B represents the center distance between the two lenses 210 and 220 of the pair of cameras 200, which is the distance between the two nodes of the lenses 210 and 220. X represents a specific object point being photographed, and x and x′ are the actual projection positions of X on the photosensitive elements corresponding to lenses 210 and 220, respectively. f is the focal length of lenses 210 and 220, and Z is the depth, which is the distance from the pair of cameras 200 to an object point X. The pair of cameras 200 conforms to the following formulas:

$$( x - {x}^{′} ) = \frac{fB}{Z} \qquad Formula ( 1 )$$

$$( x - {x}^{′} ) = \frac{1}{{m}_{c}} ( {u}_{L} - {u}_{R} ) \qquad Formula ( 2 )$$

$${m}_{c} = \frac{number of pixels}{mm} \qquad Formula ( 3 )$$

Here, mc represents the pixel density, for example, as defined in Formula (3), which indicates the number of pixels per millimeter on the photosensitive element. From Formulas (1) and (2), it may be observed that a depth Z is determined by the pixel position difference (u_{L}-u_{R}) of the projection of the object point X on the two photosensitive elements. Here, u_{L} represents the pixel position of the projection of the object point X on the photosensitive element corresponding to lens 210, and up represents the pixel position of the projection of the object point X on the photosensitive element corresponding to lens 220. By adjusting the pixel difference in the images obtained from the two photosensitive elements, the depth Z may be adjusted. In other words, in step S140, the binocular disparity (u_{L}-u_{R}) of the first cropped image and the second cropped image may be obtained.

FIG. 9 is a schematic diagram showing the resolution adjustment of the first cropped image and the second cropped image back to the resolution of the first image and the second image. Referring to FIGS. 1, 4, and 9, in this embodiment, the controller 110 is further configured to execute: adjusting the resolution of the first cropped image and the second cropped image back to the resolution of the first image 212 and the second image 222, and multiplying a binocular disparity d1 of the first cropped image and the second cropped image by a first proportional constant corresponding to the resolution adjustment to obtain a magnified binocular disparity d₃, which involves the following Formulas:

$${d}_{1} = {m}_{c} ( x - {x}^{′} ) = ( {u}_{L} - {u}_{R} ) \qquad Formula ( 4 )$$

$${d}_{3} = \frac{{x}_{3}}{{x}_{2}} \cdot {d}_{1} \qquad Formula ( 5 )$$

Here, x₂ represents the number of pixels along the longer side of the first cropped image or the second cropped image, and x₃ represents the number of pixels along the longer side of the first image 212 or the second image 222. In other words, when the resolution of the first cropped image or the second cropped image is enlarged to match the resolution of the first image 212 or the second image 222, the binocular disparity d₁ is also proportionally enlarged to become the magnified binocular disparity d₃. In this embodiment, both the binocular disparity d1 of the first cropped image and the second cropped image and the magnified binocular disparity d₃ are pixel-based binocular disparities.

On the other hand, in step S150, the viewing distance (i.e., the distance d) from the stereoscopic display 300 to the user's eye 60 is measured. In this embodiment, the controller 110 is used to command a camera, two cameras, or a distance sensor 310 disposed on the stereoscopic display 300 to measure the viewing distance (i.e., the distance d).

Then, in step S160, the comfortable range RE of the binocular vergence distance is defined according to the viewing distance (i.e., the distance d) from the stereoscopic display 300 to the user's eye 60, as shown in FIG. 2.

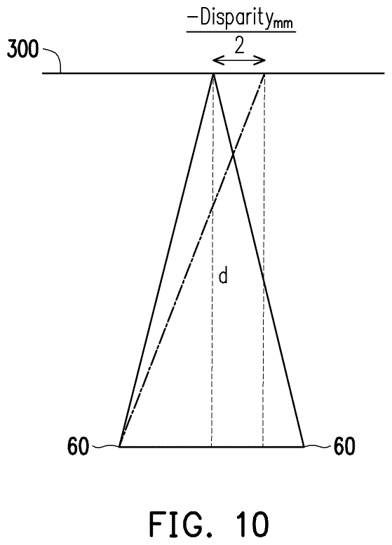

FIG. 10 is a basic configuration diagram showing the user viewing the stereoscopic display in FIG. 1. Referring to FIG. 10, the distance between the user's eye 60 and the screen is the viewing distance d, and the binocular disparity is Disparityₘₘ, measured in millimeters (mm). The following relationship, Formula (6), may be derived. To achieve the comfortable range RE, at the boundary of the comfortable range, there is a constraint relationship between d and Disparityₘₘ as shown in Formula (6):

$${tan}^{- 1} ( \frac{- \frac{1}{2} {Disparity}_{mm}}{d} ) = \pm 0.5 ° \qquad Formula ( 6 )$$

Since the unit stored by the camera is in pixels, the binocular disparity captured by the left and right cameras for the object 50 is also in pixels. Therefore, Disparityₘₘ must be converted to Disparityₚᵢₓₑₗ, where Disparityₚᵢₓₑₗ represents binocular disparity in pixel units. Assuming, in an embodiment, the 15.6-inch screen width of the stereoscopic display 300 is 344.2176 mm and the horizontal resolution of the image stored by the camera is 3840 pixels, the relationship for disparity conversion is: 344.2176 mm/6840 pixels=0.08964 mm/pixel. This means Disparityₘₘ may be converted to Disparityₚᵢₓₑₗ by dividing Disparityₘₘ by 0.08964 mm/pixel. Referring to FIG. 3, converting Disparityₘₘ obtained from Formula (6) into Disparityₚᵢₓₑₗ establishes the relationship between d and Disparityₚᵢₓₑₗ. Assuming a 15.6-inch screen and a viewing distance d of approximately 60 cm, to satisfy the conditions of the comfortable range RE, the disparity of the stereoscopic image content must be within ±117 pixels. Using this constraint, the design parameters for the pair of cameras 200 may be determined in reverse.

Referring to FIGS. 1 and 4, the next step is step S170. In this step, according to the comfortable range RE, the first cropped image, and the second cropped image, a corrected binocular disparity is calculated as follows:

$$( {u}_{L}^{′} - {u}_{R}^{′} ) = {d}_{3} + {ε}_{ps} \qquad Formula ( 7 )$$

Here, (u′_{L}-u′_{R}) represents the corrected binocular disparity. For example, u′_{L} represents the pixel position of the object point X in the upscaled resolution of the first cropped image, and u′_{R} represents the pixel position of the object point X in the upscaled resolution of the second cropped image. In this embodiment, (u′_{L}−u′_{R}) may be set to +117 pixels. In this embodiment, the step of calculating the corrected binocular disparity according to the comfortable range RE, the first cropped image, and the second cropped image includes adding a correction value εₚₛ to the magnified binocular disparity d₃ to obtain the corrected binocular disparity. The correction value εₚₛ may be determined by subtracting d₃ from (u′_{L}−u′_{R}), which, for example, is set to +117 pixels.

Next, in step S180, a stereoscopic image signal having the corrected binocular disparity (u′_{L}−u′_{R}) is output to the stereoscopic display 300, enabling the stereoscopic display 300 to display stereoscopic images according to the corrected binocular disparity. In this way, the issue of visual vergence-accommodation conflict in the stereoscopic display 300 may be effectively mitigated. It is worth noting that when (u′_{L}−u′_{R}) is set at the boundary of the comfortable range RE (i.e., in this case, (u′_{L}−u′_{R}) is set to +117 pixels), the user may manually adjust the value of (u′_{L}−u′_{R}) through a user interface by means of the controller 110. This allows the user to further fine-tune the binocular disparity of the stereoscopic image to a level that feels comfortable to the individual user.

Formula (7) applies to situations where the resolution of the pair of cameras 200 matches the resolution of the stereoscopic display 300. However, if the resolution of the pair of cameras 200 differs from the resolution of the stereoscopic display 300, the controller 110 may calculate a resolution-adjusted binocular disparity by multiplying the magnified binocular disparity d₃ by a second proportional constant S, according to the proportional relationship between the resolution of the stereoscopic display 300 and the resolutions of the first image 212 and the second image 222. This results in a resolution-adjusted binocular disparity S·d₃. The step of calculating the corrected binocular disparity according to the comfortable range, the first cropped image, and the second cropped image includes adding a correction value εₚₛ to the resolution-adjusted binocular disparity S·d₃ to obtain the corrected binocular disparity (u′_{L}−u′_{R}), as shown in Formula (8):

$$( {u}_{L}^{′} - {u}_{R}^{′} ) = S \cdot {d}_{3} + {ε}_{ps} \qquad Formula ( 8 )$$

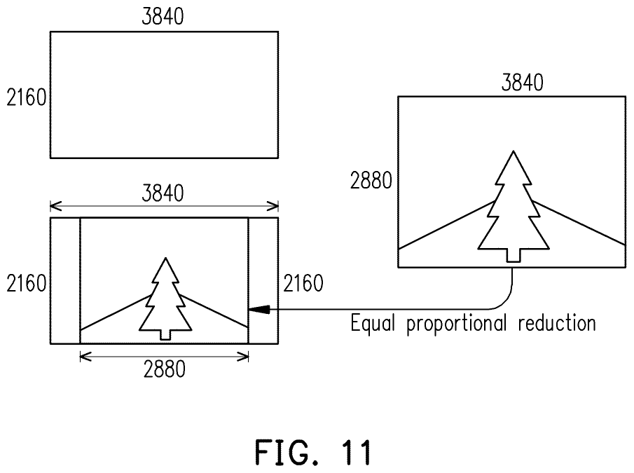

For instance, since the resolution of the pair of cameras 200 may differ from the resolution of the stereoscopic display 300, and the aspect ratio of the camera images may differ from the aspect ratio of the screen of the stereoscopic display 300, the calculation of S must be according to the resolution of the shorter side. As shown in FIG. 11, assuming the original photo resolution is 3840×2880, with the shorter side resolution being 2880, and the screen resolution of the stereoscopic display 300 is 3840×2160, with the shorter side resolution being 2160, then S is not equal to 1. In this case, S=2160/2880=0.75.

In an embodiment, the controller 110 may be, for example, a central processing unit (CPU), a microprocessor, a digital signal processor (DSP), a programmable controller, a programmable logic device (PLD), or other similar devices or a combination of these devices. The disclosure is not limited to any specific implementation. Additionally, in an embodiment, the various functions of the controller 110 may be implemented as multiple codes. These codes may be stored in a memory and executed by the controller 110. Alternatively, in an embodiment, the functions of the controller 110 may be implemented as one or more circuits. The disclosure does not limit the implementation of the functions of the controller 110 to either software or hardware.

In this embodiment, the controller 110 may be integrated with the pair of cameras 200, or integrated with the stereoscopic display 300, or independently configured in a computer host, without being integrated with the cameras 200 or the stereoscopic display 300. Alternatively, the controller 110 may be partially integrated with the cameras 200, with another part integrated with the stereoscopic display 300. When the controller 110 is integrated with the stereoscopic display 300, both the controller 110 and the stereoscopic display 300 may belong to a single computer, such as a laptop or an all-in-one computer. However, the disclosure is not limited to these configurations.

In summary, in the automatic disparity adjustment method and the automatic disparity adjustment system of the embodiments of the disclosure, a comfortable range of the binocular vergence distance is defined according to the viewing distance from the stereoscopic display to the user's eyes. Additionally, a corrected binocular disparity is calculated according to the comfortable range, the first cropped image, and the second cropped image. Consequently, the binocular vergence distance of the stereoscopic image displayed by the stereoscopic display according to this corrected binocular disparity lies within the comfortable range, effectively reducing the issue of visual vergence-accommodation conflict. Therefore, the automatic disparity adjustment method and the automatic disparity adjustment system of the embodiments of the disclosure may effectively suppress the issue of visual vergence-accommodation conflict.

What is claimed is:

1. An automatic disparity adjustment method, comprising:
photographing an object using a pair of cameras to obtain a first image and a second image, wherein a distance exists between two lenses of the pair of cameras;
correcting the first image using a first correction matrix to obtain a first corrected image, and correcting the second image using a second correction matrix to obtain a second corrected image, wherein the first corrected image and the second corrected image simulate two images obtained by the pair of cameras when two optical axes of the two lenses are parallel;
cropping the first corrected image and the second corrected image to retain an overlapping portion of the first corrected image and the second corrected image, wherein a first cropped image is obtained after the first corrected image is cropped, and a second cropped image is obtained after the second corrected image is cropped;
estimating a binocular disparity of the first cropped image and the second cropped image according to a focal length of the two lenses, a pixel size of the pair of cameras, the first cropped image, and the second cropped image;
measuring a viewing distance from a stereoscopic display to an eye of a user;
defining a comfortable range of a binocular vergence distance according to the viewing distance;
calculating a corrected binocular disparity according to the comfortable range, the first cropped image, and the second cropped image; and
causing the stereoscopic display to display a stereoscopic image according to the corrected binocular disparity.

2. The automatic disparity adjustment method according to claim 1, further comprising:
adjusting a resolution of the first cropped image and the second cropped image back to a resolution of the first image and the second image, and multiplying the binocular disparity of the first cropped image and the second cropped image by a first proportional constant corresponding to the resolution adjustment to obtain a magnified binocular disparity, wherein calculating the corrected binocular disparity according to the comfortable range, the first cropped image, and the second cropped image comprises adding a correction value to the magnified binocular disparity to obtain the corrected binocular disparity.

3. The automatic disparity adjustment method according to claim 1, further comprising:
adjusting a resolution of the first cropped image and the second cropped image back to a resolution of the first image and the second image, and multiplying the binocular disparity of the first cropped image and the second cropped image by a first proportional constant corresponding to the resolution adjustment to obtain a magnified binocular disparity; and
according to a proportional relationship between a resolution of the stereoscopic display and the resolution of the first image and the second image, multiplying the magnified binocular disparity by a second proportional constant to obtain a resolution-adjusted binocular disparity, wherein calculating the corrected binocular disparity according to the comfortable range, the first cropped image, and the second cropped image comprises adding a correction value to the resolution-adjusted binocular disparity to obtain the corrected binocular disparity.

4. The automatic disparity adjustment method according to claim 1, wherein measuring the viewing distance from the stereoscopic display to the eye of the user comprises measuring the viewing distance using a camera, two cameras, or a distance sensor configured on the stereoscopic display.

5. The automatic disparity adjustment method according to claim 1, wherein the binocular disparity of the first cropped image and the second cropped image is the binocular disparity in a unit of a pixel.

6. An automatic disparity adjustment system, comprising:
a pair of cameras, used to photograph an object to obtain a first image and a second image, wherein the pair of cameras comprises two lenses, and a distance exists between the two lenses; and
a controller, signally connected to the pair of cameras, and configured to execute:
correcting the first image using a first correction matrix to obtain a first corrected image, and correcting the second image using a second correction matrix to obtain a second corrected image, wherein the first corrected image and the second corrected image simulate two images obtained by the pair of cameras when two optical axes of the two lenses are parallel;
cropping the first corrected image and the second corrected image to retain an overlapping portion of the first corrected image and the second corrected image, wherein a first cropped image is obtained after the first corrected image is cropped, and a second cropped image is obtained after the second corrected image is cropped;
estimating a binocular disparity of the first cropped image and the second cropped image according to a focal length of the two lenses, a pixel size of the pair of cameras, the first cropped image, and the second cropped image;
defining a comfortable range of a binocular vergence distance according to a viewing distance from a stereoscopic display to an eye of a user;
calculating a corrected binocular disparity according to the comfortable range, the first cropped image, and the second cropped image; and
outputting a stereoscopic image signal having the corrected binocular disparity to the stereoscopic display.

7. The automatic disparity adjustment system according to claim 6, wherein the controller is configured to further execute:
adjusting a resolution of the first cropped image and the second cropped image back to a resolution of the first image and the second image, and multiplying the binocular disparity of the first cropped image and the second cropped image by a first proportional constant corresponding to the resolution adjustment to obtain a magnified binocular disparity, wherein calculating the corrected binocular disparity according to the comfortable range, the first cropped image, and the second cropped image comprises adding a correction value to the magnified binocular disparity to obtain the corrected binocular disparity.

8. The automatic disparity adjustment system according to claim 6, wherein the controller is configured to further execute:
adjusting a resolution of the first cropped image and the second cropped image back to a resolution of the first image and the second image, and multiplying the binocular disparity of the first cropped image and the second cropped image by a first proportional constant corresponding to the resolution adjustment to obtain a magnified binocular disparity; and
according to a proportional relationship between a resolution of the stereoscopic display and the resolution of the first image and the second image, multiplying the magnified binocular disparity by a second proportional constant to obtain a resolution-adjusted binocular disparity, wherein calculating the corrected binocular disparity according to the comfortable range, the first cropped image, and the second cropped image comprises adding a correction value to the resolution-adjusted binocular disparity to obtain the corrected binocular disparity.

9. The automatic disparity adjustment system according to claim 6, wherein the controller is used to command a camera, two cameras, or a distance sensor configured on the stereoscopic display to measure the viewing distance.

10. The automatic disparity adjustment system according to claim 6, wherein the binocular disparity of the first cropped image and the second cropped image is the binocular disparity in a unit of a pixel.
